(19) United States
(12) Patent Application Publication
(10) Pub. No.: US 2008/0219491 A1
(43) Pub. Date: Sep. 11, 2008

(54) VARIABLE EARPHONES AND SPEAKER

(76) Inventor: Amit Ahuja, Alpine, NJ (US)

Correspondence Address: MEREDITH & KEYHANI, PLLC, 330 MADISON AVE., 6TH FLOOR, NEW YORK, NY, 10017, US

(21) Appl. No.: 11/684,438

(22) Filed: Mar. 9, 2007

(51) Int. Cl. H04R 25/00

(52) U.S. Cl. 381/370

(57) ABSTRACT

A variable speaker and earphone apparatus having a first and second earphone having an inside portion with an earphone speaker and an outside portion with a speaker having at least one subwoofer; a switching means in communication with the first earphone and the second earphone, wherein the switching means provides variable sound to either the outside portion of the first earphone and the outside portion of the second earphone or the inside portion of the first earphone and the inside portion of the second earphone or the outside portion of the first earphone, the outside portion of the second earphone, the inside portion of the first earphone and the inside portion of the second earphone; a power means, wherein the power means is in communication with the first earphone, the second earphone and the switching means; and a communication means for communicating sound from a source to the first earphone and the second earphone.

The present invention relates to earphones that may variably switch between earphones and speakers.

Music devices are becoming more and more common and interchangeable with ipods and mp3 players carrying entire catalogs of music. However, many times the user of such a device may want to turn their device into a stereo for others to enjoy and listen to the music. This may be desirable, by way of example, for traveling and camping trips. Currently, users may bring a separate set of speakers. However, this can be cumbersome and duplicative.

Another problem is that the user may want to be able to adjust the sound variably. For example, it may be desirable to be listening to your music and want to share the music with a person to the right of you. In this way, you may keep the earphone speakers on and turn the outside right speaker up so that the person to the right of you may be able to hear. You may also want to fill the entire room with sound, for example at your office. The present invention solves this problem by providing a docking station that holds the earphone speakers in an upright position and powers the apparatus.

Accordingly, the present invention provides an earphone that may be variable adjusted to provide earphones and speakers.

### SUMMARY OF THE INVENTION

The present invention relates generally to sound devices and in particular earphones.

According to one embodiment, a convertible speaker and earphone apparatus, the apparatus comprising: a first earphone having an inside portion with an earphone speaker and an outside portion with a speaker having at least one subwoofer; a second earphone having an inside portion with earphone speaker and an outside portion with a speaker having at least one subwoofer, wherein the second earphone is in audio communication with the first earphone; a switching means in communication with the first earphone and the second earphone, wherein the switching means provides variable sound to either the outside portion of the first earphone and the outside portion of the second earphone or the inside portion of the first earphone and the inside portion of the second earphone or the outside portion of the first earphone, the outside portion of the second earphone, the inside portion of the first earphone and the inside portion of the second earphone; a power means, wherein the power means is in communication with the first earphone, the second earphone and the switching means; and a communication means for communicating sound from a source to the first earphone and the second earphone.

According to another embodiment, A convertible speaker and earphone apparatus, the apparatus comprising: a first earphone having an inside portion with an earphone speaker and an outside portion with a speaker having at least one subwoofer; a second earphone having an inside portion with earphone speaker and an outside portion with a speaker having at least one subwoofer, wherein the second earphone is in audio communication with the first earphone; a switching means in communication with the first earphone and the second earphone, wherein the switching means provides variable sound to the outside portion of the first earphone and the outside portion of the second earphone or the inside portion of the first earphone and the inside portion of the second earphone or the outside portion of the first earphone, the outside portion of the second earphone, the inside portion of the first earphone and the inside portion of the second earphone; a power means, wherein the power means is in communication with the first earphone, the second earphone and the switching means; a communication means for communicating sound from a source to the first earphone and the second earphone; a docking station for providing power and stability to the convertible speaker and earphone apparatus, the docking station having a cavity being configured to removably receive and provide power to the convertible speaker and earphone apparatus.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention; and

FIG. 3 depicts the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

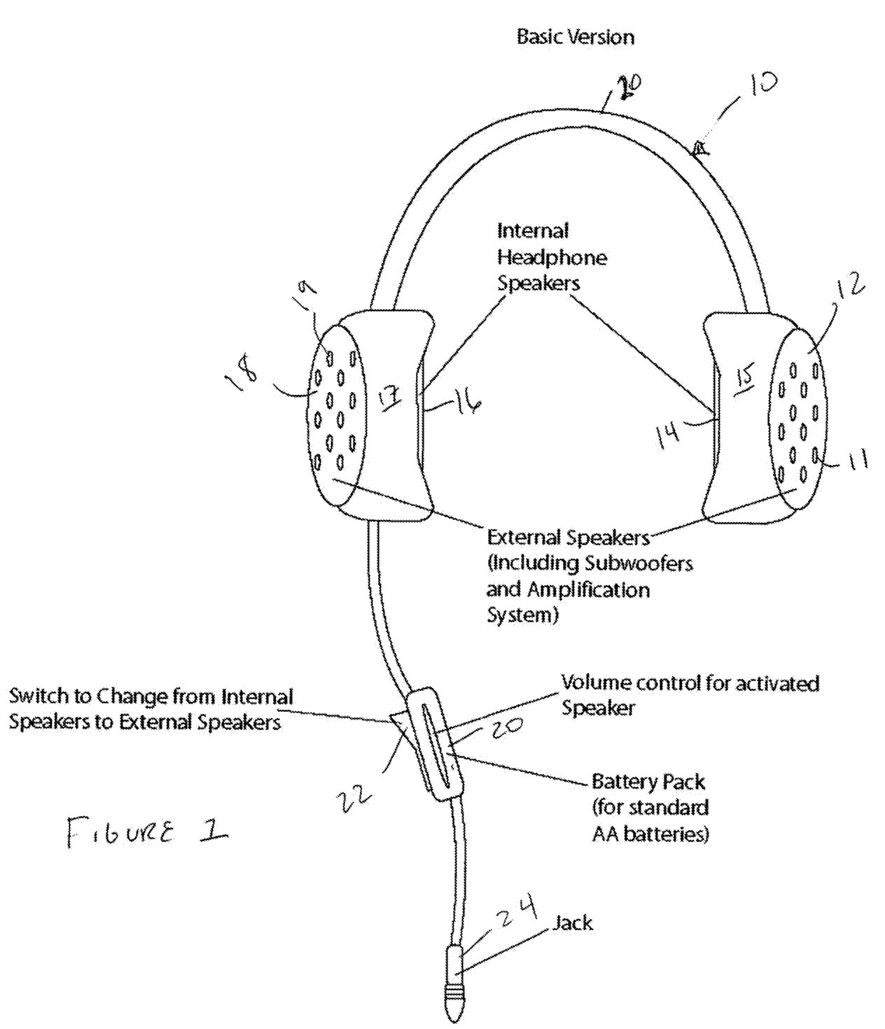

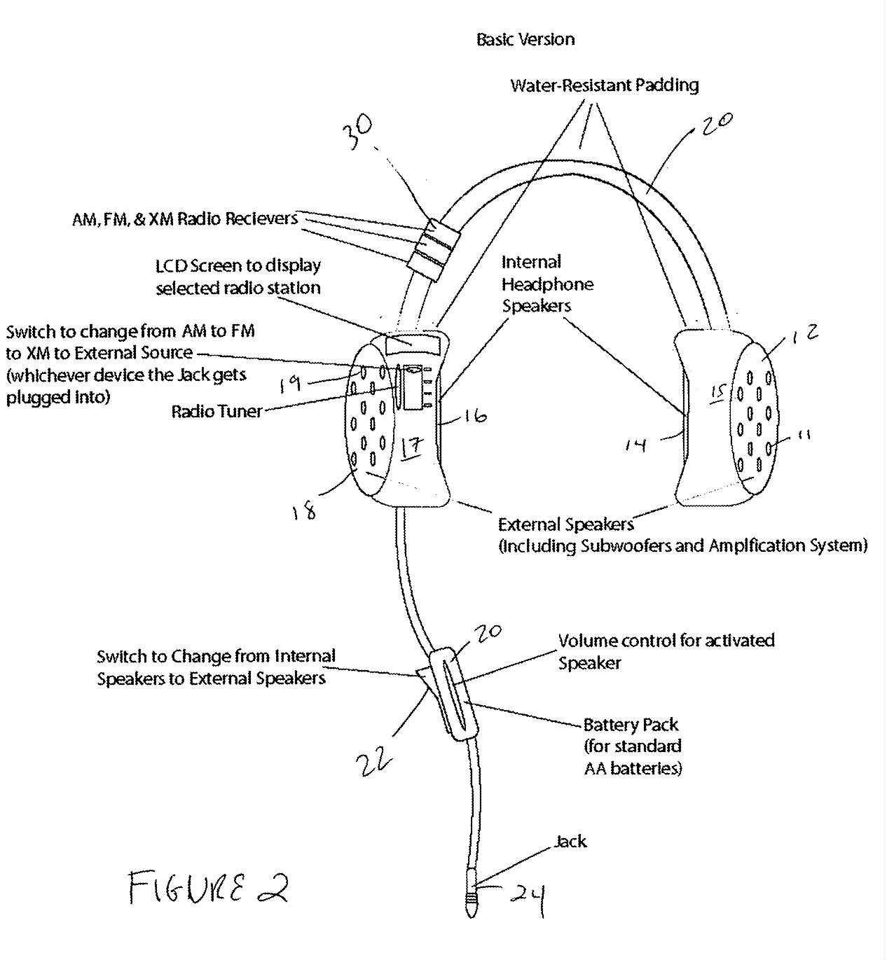

As depicted in FIGS. 1-2, a convertible speaker and earphone apparatus (10), the apparatus (10) comprising: a first earphone (17) having an inside portion with an earphone speaker (16) and an outside portion with a speaker having (18) at least one subwoofer (19); a second earphone (15) having an inside portion with earphone speaker (14) and an outside portion with a speaker (12) having at least one subwoofer (11), wherein the second earphone (15) is in audio communication with the first earphone (17); a switching means (22) in communication with the first earphone and the second earphone, wherein the switching means (22) provides variable sound to either the outside portion of the first earphone (18) and the outside portion of the second earphone (12) or the inside portion (16) of the first earphone and the inside portion (14) of the second earphone or the outside portion (18) of the first earphone, the outside portion of the second earphone (12), the inside portion of the first earphone (16) and the inside portion of the second earphone (14). It should be understood the sound may be variable between inside (16) and outside (18) of the first/left (17) earphone and the inside (14) and outside (11) of the second/right (15) earphone. This means the variable sound may be between the left and right and inside and outside and any combination thereof. So, the user may turn up or down the sound on the outside right or the outside left individually or together, or they may turn up or down the sound on the inside right or inside left individually or together. There is also a power means (20), wherein the power means is in communication with the first earphone (17), the second earphone (15) and the switching means (22); and a communication means (e.g. 24) for communicating sound from a source to the first earphone (17) and the second earphone (15). The communication means may be Bluetooth, cord and jack, wireless or any other communication means known within the art. The switching means (22) may provide variable sound according to the inside and outside of the earphones, but also according to the left (first earphone 17) and right (second earphone 15). This may be desirable in the situation where you are listening to music and want to share the music with someone sitting to the left (or right) of you, but do not wish to broadcast both speakers to disturb others. Also, because it is variable, you may wish to have the earphones high and low volume on only one speaker so that the person next to you may hear. There may be a connecting means (2) for connecting the first earphone (17) to the second earphone (15). There may be a receiver (30) contained within the connecting means (20). The power means may be a battery, a rechargeable battery, a plug, or any other means to provide power that is known within the art. It is envisioned that the earphones may be in communication with any device requiring a sound input including an mp3 player, ipod, stereo, television or any other device that would require a sound output.

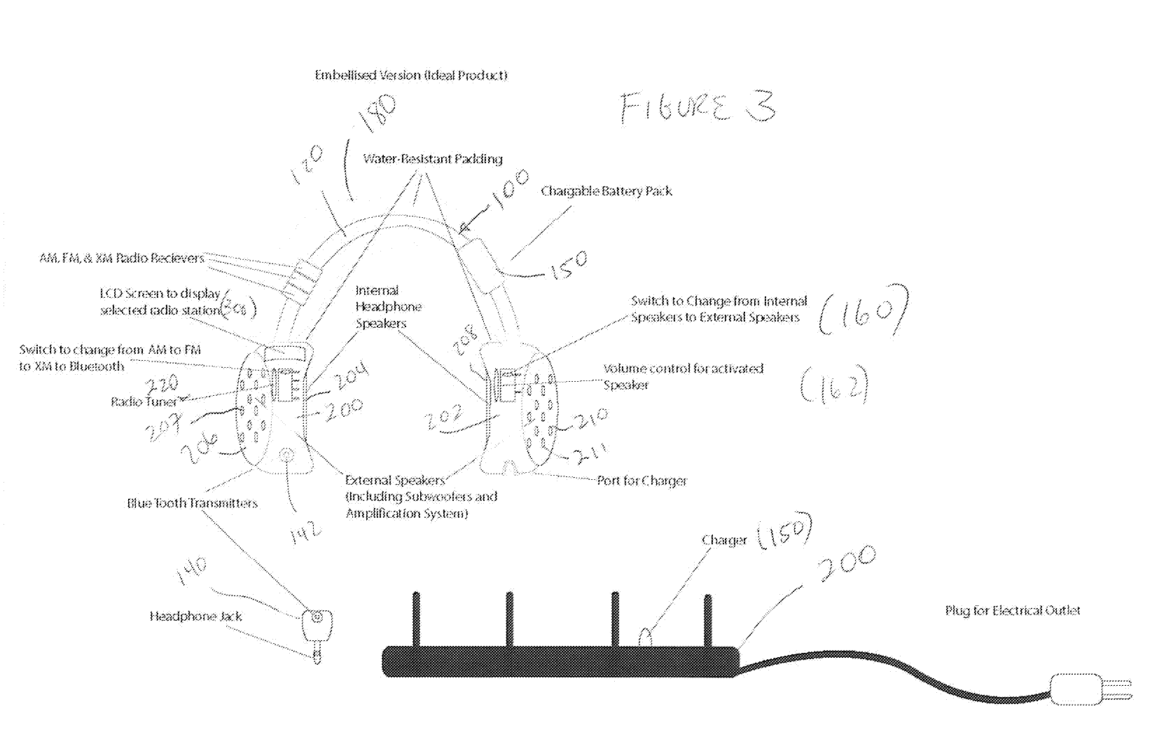

As shown in FIG. 3, the apparatus my have a docking station (200) for providing power and stability to the convertible speaker and earphone apparatus (100), the docking station being configured to removably receive and provide power to said convertible speaker and earphone apparatus. According to the embodiment shown the apparatus (100) is wireless and utilizes a Bluetooth transmitter (140,142) and the power means may be a rechargeable battery pack (150) incorporated in the apparatus (100). In the wireless embodiment, the switching means (160) may include the volume control (162). There may also be a switch to have the switching means (160) switch from the left earphone (200) to the right earphone (202) and to provide variable sound between the inside portion (204) of the left earphone (200) and the outside portion (206) of the left earphone (200) and the inside portion (208) and outside portion (210) of the right earphone (202). The outside portion (206) of the left earphone (200) may also be a composite chamber having a plurality of subspeakers (207). The outside portion (210) of the right earphone (202) may also be a composite chamber having a plurality of subspeakers (211). There may be a water resistant padding (180) in communication with and surrounding the connecting means (120). There may also be at least one amplifier contained within the outside portion (206) of the first earphone (200) and the outside portion (210) of the second earphone (202). There may also be at least one radio tuner (220) in the inside portion of the first earphone (200) or second earphone (202). There may also be an LCD screen (300) to display the radio station or any other information.

It should be understood that the foregoing relates to preferred embodiments of the invention and that modifications may be made without departing from the spirit and scope of the invention as set forth in the following claims.

1. A convertible speaker and earphone apparatus, said apparatus: comprising:
a first earphone having an inside portion with an earphone speaker and an outside portion with a speaker having at least one subwoofer;
a second earphone having an inside portion with earphone speaker and an outside portion with a speaker having at least one subwoofer, wherein said second earphone is in audio communication with said first earphone;
a switching means in communication with said first earphone and said second earphone, wherein said switching means provides variable sound to either said outside portion of said first earphone and said outside portion of said second earphone or said inside portion of said first earphone and said inside portion of said second earphone or said outside portion of said first earphone, said outside portion of said second earphone, said inside portion of said first earphone and said inside portion of said second earphone;
a power means, wherein said power means is in communication with said first earphone, said second earphone and said switching means; and
a communication means for communicating sound from a source to said first earphone and said second earphone.

2. A convertible speaker and earphone apparatus as in claim 1, further comprising:
a docking station for providing power and stability to said convertible speaker and earphone apparatus, said docking station having being configured to removably receive and provide power to said convertible speaker and earphone apparatus.

3. A convertible speaker and earphone apparatus as in claim 1, further comprising:
a connecting means for connecting said first earphone to said second earphone.

4. A convertible speaker and earphone apparatus as in claim 3, further comprising:
a receiver contained within said connecting means.

5. A convertible speaker and earphone apparatus as in claim 3, further comprising a water resistant padding in communication with and surrounding said connecting means.

6. A convertible speaker and earphone apparatus as in claim 1, further comprising at least one amplifier contained within said outside portion of said first earphone and said outside portion of said second earphone.

7. A convertible speaker and earphone apparatus as in claim 1, further comprising at least one radio tuner in said inside portion of said first earphone or said second earphone.

8. A convertible speaker and earphone apparatus as in claim 1, wherein said communication means is selected from the group consisting of Bluetooth, cord and jack, and wireless.

9. A convertible speaker and earphone apparatus as in claim 1, wherein said outside portion of said first earphone has a composite chamber having a plurality of subspeakers contained therein.

10. A convertible speaker and earphone apparatus, said apparatus comprising:
a first earphone having an inside portion with an earphone speaker and an outside portion with a speaker having at least one subwoofer;
a second earphone having an inside portion with earphone speaker and an outside portion with a speaker having at least one subwoofer, wherein said second earphone is in audio communication with said first earphone;
a switching means in communication with said first earphone and said second earphone, wherein said switching means provides variable sound to said outside portion of said first earphone and said outside portion of said second earphone or said inside portion of said first earphone and said inside portion of said second earphone or said outside portion of said first earphone, said outside portion of said second earphone, said inside portion of said first earphone and said inside portion of said second earphone;
a power means, wherein said power means is in communication with said first earphone, said second earphone and said switching means;
a communication means for communicating sound from a source to said first earphone and said second earphone;
a docking station for providing power and stability to said convertible speaker and earphone apparatus, said docking station being configured to removably receive and provide power to said convertible speaker and earphone apparatus.

11. A convertible speaker and earphone apparatus as in claim 10, further comprising:
a connecting means for connecting said first earphone to said second earphone.

12. A convertible speaker and earphone apparatus as in claim 10, further comprising:
an audio receiver contained within said connecting means.

13. A convertible speaker and earphone apparatus as in claim 10, further comprising a water resistant padding in communication with and surrounding said connecting means.

14. A convertible speaker and earphone apparatus as in claim 10, further comprising at least one amplifier contained within said outside portion of said first earphone and said outside portion of said second earphone.

15. A convertible speaker and earphone apparatus as in claim 10, further comprising at least one radio tuner in said inside portion of said first earphone or said second earphone.

16. A convertible speaker and earphone apparatus as in claim 10, wherein said communication means is selected from the group consisting of Bluetooth, cord and jack, and wireless.

17. A convertible speaker and earphone apparatus as in claim 10, wherein said outside portion of said first earphone has a composite chamber having a plurality of subspeakers contained therein.

18. A convertible speaker and earphone apparatus as in claim 10, further comprising at least one radio receiver.
